(19) United States
(12) Patent Application Publication
(10) Pub. No.: US 2014/0366381 A1
(43) Pub. Date: Dec. 18, 2014

(54) GLIDE MEMBER COMRISING LOW TO NO HYGROSCOPIC COMPONENTS FOR USE WITH A RAZOR

(71) Applicant: THE GILLETTE COMPANY, BOSTON, MA (US)

(72) Inventors: Nicola Jacqueline Phipps, Bracknell (GB); Alun Thomas Wheatley, Windsor (GB); Barry Keith Rockell, Bracknell (GB); Michael John Moloney, Brimfield, MA (US)

(21) Appl. No.: 14/296,856

(22) Filed: Jun. 5, 2014

Related U.S. Application Data
(60) Provisional application No. 61/835,810, filed on Jun. 17, 2013.

(51) Int. Cl. B26B 21/44; B26B 21/22; B26B 21/40

(52) U.S. Cl. CPC B26B 21/443; B26B 21/4012; B26B 21/225
USPC 30/41; 424/73

(57) ABSTRACT

Razors comprising a glide member comprising a low to nil level of hygroscopic components.

### BACKGROUND OF THE INVENTION

Providing soap mounted on a razor handle or cartridge is known. For example, U.S. Pat. No. 6,584,690 describes a razor that carries a shaving preparation, e.g., in the form of solid cake of soap that surrounds the cartridge. Further 2-in-1 razors are not new and have also been marketed under the Venus Breeze® line of razors and the Schick® Intuition® line of razors. See e.g. U.S. Pat. Nos. 7,811,553; 7,877,879; U.S. Patent Publ. No. 2008/0250646, 2006/0225285, 2006/080837, 2005/0011073, 2005/0278954, and 2012/0216408.

Poured glide members typically require high levels of glycerin or propylene glycol which assist in melting and pourability. In many of these formulations the levels of glycerin and/or propylene glycols can be present at levels as high as 30 to 40 percent.

The addition of the soap onto the razor can provide improved glide, such that some consumers may decide to shave without the additional use of shaving preparation. Razors comprising soap structures, however, can suffer from stability problems which can include the formation of sweat beads on the surface of the soap when the razor is stored in non air tight conditions on shelf or left out and exposed to ambient conditions. The formation of sweat beads on the soap can be unsightly and also be indicative of other stability problems which could include the soap becoming dried out and more fragile, discoloration, and changing wear properties. Further, the formation of sweat beads can make the razor more difficult to handle during manufacture and storage. To address this, many razors are often packaged in generally air tight sealed containers which keep the razor and soap components from exposure to the environment. As such, there remains a need for a razor having a specific soap formulation which is less susceptible to beading or sweating.

### SUMMARY OF THE INVENTION

One aspect of this invention relates to a razor cartridge comprising: a housing having a front edge and a rear edge; one or more shaving blades between the front edge and the rear edge; a glide member carrier; and at least one glide member composition mounted on the glide member carrier, the glide member composition comprising, less than 15% by weight of a hygroscopic component, and a soap base. Optionally, the razor cartridge may carry two or more glide member compositions, preferably two; one forward of the blades and one aft of the blades.

Another aspect of the invention provides for a method of forming a glide member composition for use with a razor comprising: a providing a soap base ingredients into a reaction vessel; saponifying said soap base ingredients to form a liquid soap base; removing hygroscopic components from said liquid soap base; drying said liquid soap base into soap noodles; and extruding said soap noodles into a soap base.

### BRIEF DESCRIPTION OF THE DRAWINGS

FIGS. 1a and 1b are rear planar views of a razor in accordance with at least one embodiment of the present invention.

FIG. 1c is a side profile view of the razor of FIGS. 1a and 1b.

FIGS. 2a and 2b are rear planar views of two glide member carriers which are in accordance with at least one embodiment of the present invention.

FIGS. 3a, 3b and 3c are rear angled views of another razor in accordance with at least one embodiment of the present invention.

FIG. 3d shows a frontal angled view of a carrier with glide members being attached.

FIGS. 4a and 4b are side views of a razor in accordance with at least one embodiment of the present invention.

FIG. 5 is a frontal view of a razor in accordance with at least one embodiment of the present invention.

FIGS. 6a-6c are side views of a razor in accordance with at least one embodiment of the present invention.

FIGS. 7a-7c are side views of a razor in accordance with at least one embodiment of the present invention.

FIGS. 8a-8b are side views of a razor in accordance with at least one embodiment of the present invention.

FIGS. 9a-9c are side views of a razor in accordance with at least one embodiment of the present invention.

FIGS. 10a-10b are side views of a razor in accordance with at least one embodiment of the present invention.

FIG. 11 is a frontal view of a razor in accordance with at least one embodiment of the present invention.

FIGS. 12a-12c are side views of a razor in accordance with at least one embodiment of the present invention.

### DETAILED DESCRIPTION OF THE INVENTION

The present invention relates to a razor having one or more glide members comprising a soap base affixed to a base or housing. Preferably, the soap base is less prone to stability issues encountered with many other soap base formulations. In one embodiment, the soap base is specifically selected to be less prone to the formation of sweat beads. Without intending to be bound by theory, it is believed that compositional stability of the soap can benefit from minimizing the level of hygroscopic components, such as glycerin. It is believed that by minimizing or removing hygroscopic components can reduce the degree or occurrence of sweat bead formation when the razor is exposed to ambient conditions, such as in a user's bathroom.

### I. GLIDE MEMBER

a. Hygroscopic Component

The glide member composition of the present invention comprises a low level of hygroscopic components. Those of skill in the art will appreciate that “hygroscopic” describes compositions which absorb or adsorbs water from its surroundings. Non-limiting examples of such materials include glycerine, polyhydric alcohols, zinc chloride, sodium chloride, sodium hydroxide crystals, and other hygroscopic materials described herein. In one embodiment, the glide member composition has minimal levels of glycerine, any polyhydric alcohols, or both.

In one embodiment, the level of hygroscopic components is less than about 15% by weight of the glide member composition, preferably less than about 12%, less than about 8%, less than about 6%, less than about 4%, less than about 2%, less than about 1%, less than about 0.5%. In one embodiment, the glide member composition is free or essentially free of any hygroscopic components. As defined herein, “essentially free of a component” means that no amount of that component is deliberately incorporated into the composition. Those of skill in the art will appreciate that trace levels of said ingredient may be brought over with other feeds and as such may be detectable in the final formulation in trace levels but would not be intentionally added.

b. Soap Base

The glide member composition includes a soap base. The basic component of the soap base can be a vegetable oil or tallow, saponified or neutralized to form the base, or can be a synthetic soap base.

The soap base can be a synthetic soap base. In certain embodiments, the synthetic soap base includes a low level of glycol (e.g., diproylene glycol, propylene glycol, tripropylene glycol, and/or methylpropane diol glycol), glycerin, fatty acid salts (e.g., sodium stearate and/or potassium stearate), C15-C25 alcohols (e.g., behenyl alcohol, stearyl alcohol, cetyl alcohol, and/or myristic alcohol), steareth (e.g., a steareth 21 such as, for example, Brij®-721), stearic acid, microcrystalline wax (e.g., microcrystalline wax SP 16, SP 19, SP 16, SP 18, SP-1674, SP 16W, SP 60W, SP 89, Multiwax 180M, X-145, W-445, and/or W-835), one or more surfactants (e.g., Tegobetaine F-50, Lonzaine®, the Mackam® family of surfactants, the Mirataine® family of surfactants, and sodium lauryl ether sulfate (“SLES”) (e.g., 25% active SLES). Synthetic soap bases can be extruded or hot poured. Those of skill in the art will appreciate that the level of hygroscopic ingredients will need to be limited where making an extruded soap to ensure that the optimal phase structure of the soap is maintained, enabling robustness of the soap wing on the attachment.

The soap base can, in certain embodiments, include from about 0% to about 15% glycol (e.g., from about 0.5% to about 10% glycol or from about 0.5% to about 5% glycol), from about 0% to about 10% glycerin (e.g., from about 0.5% to about 7.5% glycerin or from about 0.5% to about 6% glycerin), from about 20% to about 40% fatty acid salt (e.g., from about 25% to about 40% fatty acid salts (e.g., stearate) or from about 30% to about 35% fatty acid salt), from about 0.1% to about 10% stearic acid (e.g., from about 2 to about 5% stearic acid), from about 0.5% to about 10% microcrystalline wax (e.g., from about 0.5% to about 5% microcrystalline wax or from about 1% to about 3% microcrystalline wax), from about 1% to about 15% betaine (e.g., from about 2% to about 10% active betaine or from about 4% to about 9% active betaine), and from about 1 to about 20% active SLES (e.g., from about 1% to about 20% active SLES or from about 10% to about 15% active SLES), all based on the weight of the soap base.

In some embodiments, a combination of base and synthetic surfactants can be employed.

The soap used on the razor of the present invention will typically comprise a soap surfactant, or in short “soap”, in an amount ranging from about 40%, 45%, 50% or more of soap. In one embodiment, where working with an extruded soap, the level of soap in the glide member portion can be higher, such as at least 75%, 84%, even up to 99%. This is believed to assist in providing a structurable soap that is robust structure that can remain attached to the razor. The term “soap” is used herein in its popular sense, i.e., the alkali metal or alkanol ammonium salts of alkane- or alkene monocarboxylic acids. Sodium, magnesium, potassium, calcium, mono-, di- and tri-ethanol ammonium cations, or combinations thereof are suitable for purposes of the present invention. In general, sodium soaps are used in the compositions of this invention, but from about 1% to about 25% of the soap may be ammonium, potassium, magnesium, calcium or a mixture of these soaps. The soaps useful herein are the well known alkali metal salts of alkanoic or alkenoic acids having about 12 to 22 carbon atoms, preferably about 12 to about 18 carbon atoms. They may also be described as alkali metal carboxylates of alkyl or alkene hydrocarbons having about 12 to about 22 carbon atoms.

Soaps having the fatty acid distribution of coconut oil may provide the lower end of the broad molecular weight range. Those soaps having the fatty acid distribution of peanut or rapeseed oil, or their hydrogenated derivatives, may provide the upper end of the broad molecular weight range.

It can be preferred to use soaps having the fatty acid distribution of tallow and vegetable oil. More preferably, the vegetable oil is selected from the group consisting of palm oil, coconut oil, palm kernel oil, palm oil stearine, and hydrogenated rice bran oil, or mixtures thereof, since these are among the more readily available fats. Especially preferred are palm oil stearine, palm kernel oil, and/or coconut oil. The proportion of fatty acids having at least 12 carbon atoms in coconut oil soap is about 85%. This proportion will be greater when mixtures of coconut oil and fats such as tallow, palm oil, or non-tropical nut oils or fats are used, wherein the principal chain lengths are C16 and higher.

A preferred soap is sodium soap using palm oil stearine and palm kernel oil or coconut oil. The soaps may contain unsaturated fatty acid in accordance with commercially acceptable standards. An excessive degree of unsaturation in the soap is normally avoided.

Soaps may be made by the classic kettle boiling process or modern continuous soap manufacturing processes wherein natural fats and oils such as tallow or coconut oil or their equivalents are saponified with an alkali metal hydroxide using procedures well known to those skilled in the art. Alternatively, the soaps may be made by neutralizing fatty acids, such as lauric (C12), myristic (C14), palmitic (C16), or stearic (C18) acids with an alkali metal hydroxide or carbonate.

### II. METHODS OF MAKING THE GLIDE MEMBER COMPOSITION

Bar soaps can be customarily prepared either by framing/casting or by milling/plodding. Framed or cast soaps are typically prepared by reacting an appropriate fat, oil or carboxylic acid with a base in the presence of water to form soap, pouring the molten soap into a frame or a mold, allowing the soap to cool and harden. Milled/plodded soap bars are produced by subjecting the neutralized soap to various finishing steps which alter the crystalline matrix of the soap from the omega phase, as formed in framed/cast soap bars, to the beta phase.

In one embodiment, the glide member composition is formed of a soap base which is made from saponification of oils and then extruded to form soap noodles. This process is particularly useful for manufacture of soap base compositions which are low in hygroscopic components as these components (such as glycerin) can be removed during processing after saponification.

### Extruded Soap

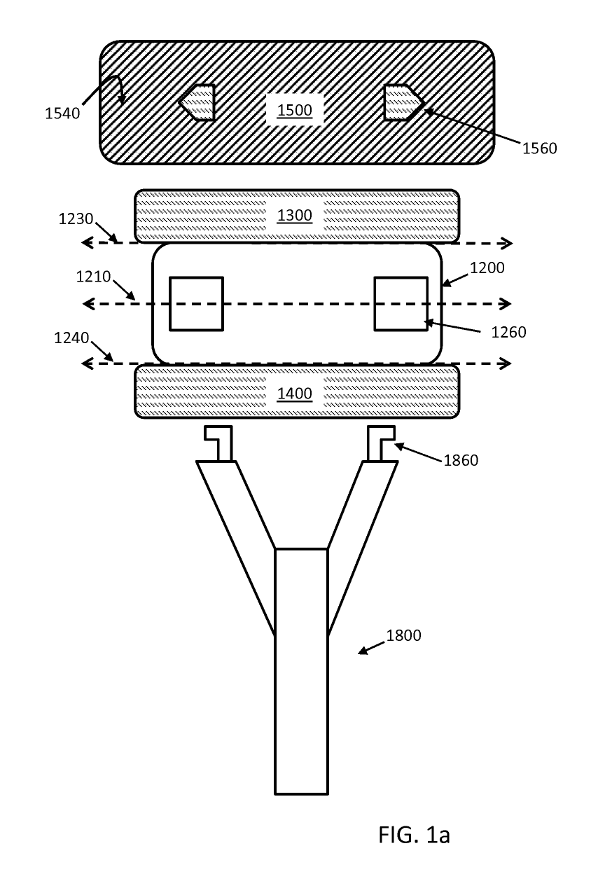

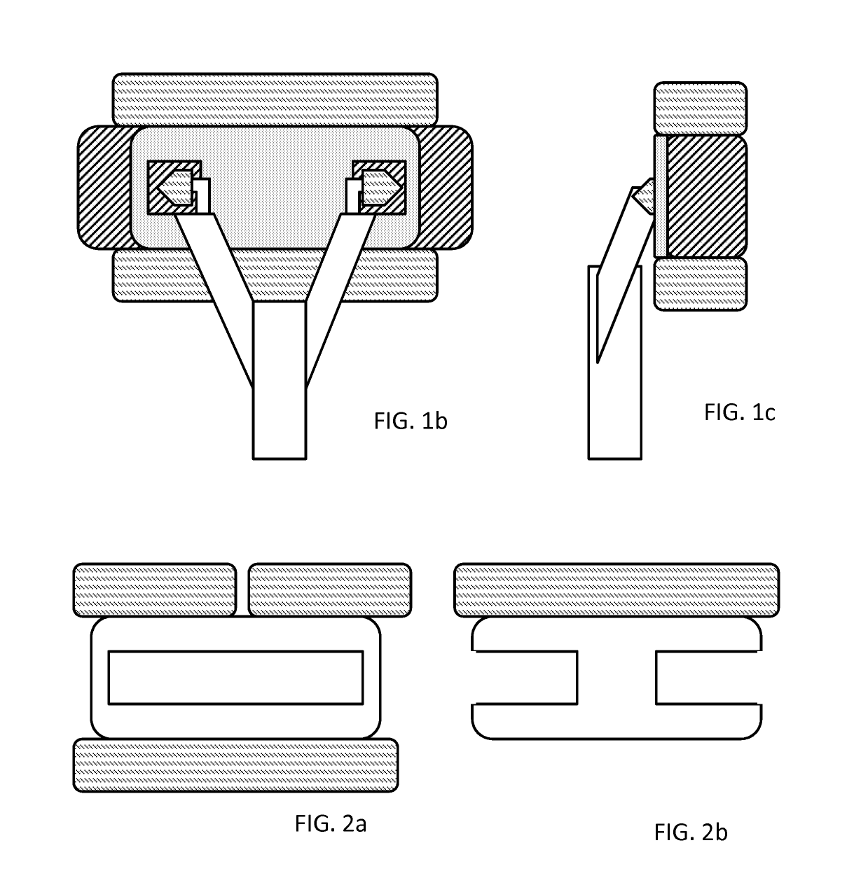

An extruded soap can be employed in certain embodiments. Processes for forming an extruded soaps are known (See for example U.S. Pat. No. 7,811,553 at FIG. 1B and as described in the specification). The soap base is generally formed by combining the soap base ingredients in a reaction vessel to form a liquid soap base (e.g., by saponification or neutralization reaction) and glycerin, which can be removed at varying levels from the liquid soap base. In one embodiment, all or essentially all the glycerin is removed. The liquid soap base is moved to a drying chamber where at least some of the water is removed (e.g., by vacuum spray drying) to form substantially dry soap pellets (e.g., dry soap noodles or shavings). The dry soap pellets are then introduced into an amalgamator having one or more paddles for mixing and/or grinding the dry soap pellets along with any process sensitive ingredients, which are introduced into the amalgamator, to form an extruded soap dry blend. The extruded soap dry blendcan in some embodiments be macromolecularly homogenized (e.g., a substantially even distribution of the process-sensitive ingredients among the dry soap pellets can be achieved). The extruded soap dry blend is then refined, e.g., by introducing the extruded soap dry blend into one or more rolling mills to achieve a substantially uniform texture. The extruded soap dry blend is then extruded using an extruder, optionally using heat (e.g., not more than 95° C., 90° C., 85° C., 80° C., 70° C., 60° C., 50° C., 40° C., 30° C., or not more than 25° C.) and/or pressure, to form a continuous bar of extruded soap, which can be subjected to further processing steps (e.g., cutting and/or stamping into the desired final shape).

### III. OTHER INGREDIENTS IN THE GLIDE MEMBER COMPOSITION

### Pyrithione Source

In one embodiment, the glide member may also comprise one or more pyrithione sources. As used herein, the pyrithione source can be a pyrithione and a pyrithione salt capable of providing antimicrobial efficacy and/or other aesthetic and shave benefits. Preferred pyrithione salts are those formed from heavy metals such as zinc, tin, cadmium, magnesium, aluminum and zirconium. Zinc salts are most preferred, especially the zinc salt of 1-hydroxy-2-pyridinethione (zinc pyridinethione, also named zinc pyrithione, ZPT). Other cations such as sodium may also be suitable. The pyrithione source may be selected from the group consisting of sodium pyrithione, zinc pyrithione, magnesium disulfide pyrithione, pyrithione acid, dipyrithione, chitosan pyrithione and combinations thereof. Preferably, it is sodium pyrithione or zinc pyrithione and more preferably, it is a zinc pyrithione (ZPT). ZPT is commercially available from various suppliers. For example, ZPT FPS available from Arch Chemical can be used. It is an aqueous dispersion comprising 48% active ZPT.

Pyrithione sources are well known in the personal cleansing art, and are described, for example, in U.S. Pat. No. 2,809,971; U.S. Pat. No. 3,236,733; U.S. Pat. No. 3,753,196; U.S. Pat. No. 3,761,418; U.S. Pat. No. 4,345,080; U.S. Pat. No. 4,323,683; U.S. Pat. No. 4, 379,753; and U.S. Pat. No. 4,470,982. Descriptions about pyrithione sources in the above mentioned patents are incorporated herein by reference. The pyrithione source can be present in the glide member composition in an amount ranging from about 0.05%, 0.1% or 0.4% to about 0.5%, 1%, 2% or 5% by weight. Examples of such glide members are described in detail in U.S. Patent Publ. No. 2012/0216408A.

### Zinc Source

The glide member composition may additionally comprise a zinc source at a level of from about 0.01% to about 0.5%, by weight. Suitable zinc source include those zinc-containing materials described in U.S. Pat. No. 4,161,526, which can also provide discoloration inhibiting benefit. Specifically, the zinc source is selected from a group consisting of a zinc salt of an organic carboxylic zinc salt, inorganic zinc salt, zinc hydroxide, zinc oxide, and combinations thereof. In one embodiment, the zinc source is zinc carbonate and/or zinc oxide. The zinc source, for example, zinc carbonate is also known as being able to potentiate the efficacy of the pyrithione source. In one embodiment, the glide member comprises 0.5% zinc pyrithione, 2% sodium carbonate, and 0.1% zinc carbonate.

### Zinc Pyrithione

According to an example embodiment, the glide member can further comprise a pyrithione or a polyvalent metal salt of pyrithione such as a zinc salt of 1-hydroxy-2-pyridinethione (known as “zinc pyrithione” or “ZPT”).

In one embodiment, the zinc pyrithione included in soap base is dry powder zinc pyrithione in platelet particle form (“platelet ZPT”). According to example embodiments, the platelet ZPT included in the soap base composition can include particles with, for example, a median particle diameter of about 0.5 microns to about 10, alternatively about 1 to about 5 microns, and alternatively about 3 microns and a mean particle diameter of about 0.5 to about 10 microns, alternatively about 1 to about 5 microns, alternatively about 2 to about 4 microns, and alternatively about 3 microns. The platelet ZPT can also have a thickness of about 0.6 to about 15 microns, alternatively about 0.6 to about 1 micron, alternatively about 0.6 microns to about 0.8 microns, and alternatively about 0.6 microns to about 0.7 microns as shown in FIG. 1 of U.S. Pat. Ser. No. 13/036,889, Smith et al. filed on Feb. 28, 2011, Application Docket No. 12005. The platelet ZPT included in the glide member can also have a span of less than about 5, and alternatively about 1.

The glide member can include from about 0.01% to about 5%, by weight of the glide member, of platelet ZPT, alternatively from about 0.1% to about 2%, and alternatively from about 0.1% to about 1%. The platelet ZPT can be included in the glide member as a dry power that is, for example, dispersed with the soap ingredients. Alternatively, the platelet ZPT can be included in the glide member as aqueous dispersion with, for example, in the soap base.

### Additional Antibacterial Agents

The soap base can optionally further include one or more additional antibacterial agents that can serve to further enhance the antimicrobial effectiveness of the bar compositions. When present, the antimicrobial bar composition can include from about 0.001% to about 2%, preferably from about 0.01% to about 1.5%, more preferably from about 0.1% to about 1%, by weight of the antimicrobial bar composition. Examples of antibacterial agents that can be employed are the carbanilides, for example, triclocarban (also known as trichlorocarbanilide), triclosan, a halogenated diphenylether available as DP-300 from Ciba-Geigy, hexachlorophene, 3,4,5-tribromosalicylanilide, and salts of 2-pyridinethiol-1-oxide, salicylic acid and other organic acids. Other suitable antibacterial agents are described in detail in U.S. Pat. No. 6,488,943 (referred to as antimicrobial actives).

### pH and pH Adjusting Agents

Where ZPT is included in the glide member, the pH of the glide member composition can be greater than or equal to 10.7, preferably greater than or equal to 11, 11.5, 12, 12.5, 13, and 13.5, till up to 14. Where ZPT is not included, the glide member could have a broader range of pH, such as around 7 or higher. As used herein, pH of the present composition is measured at around 25° C. using any commercially available pH meter. When the tested composition is in a solid form, it is first dissolved in distilled water to form an aqueous solution of a concentration of 10%. The pH of this aqueous solution is then tested to be representative of the bar soap. In one embodiment, the glide member composition comprises a pH adjusting agent in a sufficient amount to attain the above mentioned pH. The pH adjusting agents useful for the present composition includes alkalizing agents. Suitable alkalizing agents include, for example, ammonia solution, triethanolamine, diethanolamine, monoethanolamine, potassium hydroxide, sodium hydroxide, sodium phosphate dibasic, soluble carbonate salts, ammonia solution, triethanolamine, diethanolamine, monoethanolamine, potassium hydroxide, sodium hydroxide, sodium phosphate dibasic, soluble carbonate salts and combinations thereof. The amount of the pH adjusting agent required to attain the requisite pH can be calculated by one skilled in the art following known chemical parameters, for example, pKa value of the pH adjusting agent.

### Other Ingredients

The bar soap can additionally comprise inorganic salts. Inorganic salts can help to bind the water in the bar composition thereby reducing water activity (“Aw”) of water in the present compositions and preventing water loss by evaporation or other means.

Structurants can also optionally be included as ingredients in the present bar soap. Suitable structurants in the present compositions include raw starch (e.g. corn, rice, potato, wheat, and the like), pregelatinzed starch, carboxymethyl cellulose, polyacrylate polyer available under the trade name of Stabylene from BF Goodrich and Carbopol from 3V Corporation, carregeenan, xanthan gum, polyethylene glycol, polyethylene oxide, and the like. Preferred structurants include raw starch and/or pregelatinized starch.

Free fatty acid can optionally be added to the present bar soap compositions to provide enhanced skin feel benefits such as softer and smoother feeling skin. Suitable free fatty acids include those derived from tallow, coconut, palm and palm kernel.

Synthetic surfactants can be optionally utilized in the present bar compositions to further improve the lathering properties of the bar soap during use. The synthetic surfactants useful in this invention include anionic, amphoteric, nonionic, zwitterionic, and cationic surfactants. In one embodiment, the glide member is free or essentially free of isethionates. This can be particularly preferable for extruded soap bases.

Brighteners can be included as optional ingredients in the present compositions at a level of from about 0.001% to about 1%, preferably from about 0.005% to about 0.5%, and more preferably from about 0.01% to about 0.1%, by weight of the composition.

Silica, or silicon dioxide, can be optionally incorporated in the present bar compositions at a level of from about 0.1% to about 15%, preferably from about 1% to about 10%, and more preferably from about 3% to about 7%, by weight of the composition. Silica is available in a variety of different forms include crystalline, amorphous, fumed, precipitated, gel, and colloidal. Preferred forms herein are fumed and/or precipitated silica.

Other optional ingredients in the present bar compositions include: perfumes, sequestering agents, coloring agents, opacifiers and pearlizers such as titanium dioxide. All of these are useful in enhancing the appearance or cosmetic properties of the product.

The appearance of the bar composition according to the present invention can be transparent, translucent, or opaque. In one embodiment, the bar composition is opaque.

### Wear Enhancers

The glide member composition includes one or more wear enhancing ingredients. Suitable wear enhancing ingredients include sodium stearate, polyoxyethylene, polyethylene, esters, and silicone polymers. Many of these ingredients (e.g., esters and polyoxyethylene) are typically process-sensitive. Wear enhancing materials can also impart other qualities or characteristics to the glide member composition, such as, e.g., increased lubrication.

### Polyoxyethylene

One suitable wear enhancing ingredient is polyoxyethylene, which is a process-sensitive material. Polyoxyethylenes are typically characterized by their nominal, or average (number average), molecular weight. The number average molecular weight is the sum of individual molecular weights divided by the number of polymers. As is known in this field, a sample of polyoxyethylene generally includes a distribution of molecular weights such that the sample will include individual polymer molecules above and below the number average molecular weight.

Inclusion of a polyoxyethylene of any nominal molecular weight can improve the wear characteristics of the glide member composition. The polyoxyethylene can have an approximate nominal molecular weight of, for example, no less than about 100,000 daltons (e.g., no less than about 500,000, 1,000,000, 2,000,000, 3,000,000, 4,000,000, 5,000,000, 6,000,000, or no less than about 7,000,000 daltons) and/or no more than about 8,000,000 daltons (e.g., no more than about 7,000,000, 6,000,000, 5,000,000, 4,000,000, 3,000,000, 2,000,000, or no more than about 1,000,000 daltons). Optionally, two or more polyoxyethylenes having different nominal molecular weights can be employed. The polyoxyethylene can be present, for example, at a level of no less than about 0.1% (e.g., no less than about 0.25%, no less than about 0.5%, no less than about 1%, no less than about 2%, no less than about 3%, no less than about 4%, no less than about 5%, no less than about 6%, no less than about 7%, no less than about 8%, or no less than about 9%) and/or no more than about 10% (e.g., no more than about 9%, no more than about 8%, no more than about 7%, no more than about 6%, no more than about 5%, no more than about 4%, no more than about 3%, no more than about 2%, no more than about 1%, or no more than about 0.5%), based on the weight of the glide member composition. Exemplary polyoxyethylenes include members of the POLYOX® family of polyoxyethylenes, available from Dow Chemicals, Union Carbide Corp, and ALKOX® polyoxyethylenes, available from Meisei Chemical Works, Kyoto, Japan.

### Silicone Polymers

Silicone polymers can also be employed as a wear enhancing ingredient. In particular, silicone cross-polymers may be used. Silicone cross-polymers are polymers including silicone (e.g., having a silicone-based backbone) that are capable of cross-linking (e.g., that are cross-linked). Silicone polymers, particularly silicone cross-polymers, can be present at levels of at least about 0.25% active in a solvent (e.g., at least about 0.5%, 1%, 1.5%, 2%, 2.5%, 3%, 3.5%, 4%, or at least about 4.5%) and/or at most about 5% (e.g., at most about 4.5%, 4%, 3.5%, 3%, 2.5%, 2%, 1.5%, 1%, or at most about 0.5%). In certain embodiments, the silicone cross-polymer will be present at levels of from about 0.25% to about 5%. Exemplary silicone cross-polymers include, for example, lauryl dimethicone/polyglycerin-3 cross-polymer (e.g., 30% lauryl dimethicone/polyglycerin-3 cross-polymer). Commercially available silicone cross-polymers are known and are disclosed in U.S. Pat. No. 7,811,553 at col. 6.

### Esters

Esters (for example, butters and other non-liquid esters) can be incorporated into the glide member composition, and can function as a wear enhancer and/or as a skin-softener. In particular, semi-solid esters may be employed and they are generally process-sensitive materials. The semi-solid esters can act as an emollient and/or as a moisturizer. Exemplary semi-solid esters include butters such as, for example, shea butter, cocoa butter, kokum butter, avocado butter, olive butter, mango butter, and mixtures thereof. Esters can be incorporated into the glide member composition in levels of no less than about 0.5% (e.g., no less than about 1%, 2%, 3%, 4%, 5%, 6%, or no less than about 7%) and/or no more than about 8% (e.g., no more than about 7%, 6%, 5%, 4%, 3%, 2%, or no more than about 1%).

### Polyethylene Compositions

The glide member composition can include one or more polyethylene compositions as wear enhancing ingredients. Generally, polyethylenes can improve the wear characteristics of the glide member composition, but are difficult to incorporate into the composition directly. Instead, the polyethylenes can be incorporated into a composition that is then incorporated into the glide member composition. For example, a composition including polyethylene, polybutene, and mineral oil (for example, sold under the trade name Covagloss by Sensient Technologies) can be employed. In some embodiments, the glide member composition will include no less than about 0.5% (e.g., no less than about 1%, 2%, 3%, 4%, 5%, 6%, or no less than about 7%) and/or no more than about 8% (e.g., no more than about 7%, 6%, 5%, 4%, 3%, 2%, or no more than about 1%) of a polyethylene, polybutene, and mineral oil composition.

Moisturizer Components and Other Optional Ingredients

The glide member composition can further include other skin care ingredients and/or other additives. Skin care ingredients that may be added to the base to enhance the composition include, but are not limited to, surfactants (e.g., sodium isostearoyl lactylate, ammonium isostearate, DEA-myristate, alkyl glyceryl sulfonate, and laureth-16), skin care agents such as petrolatum (e.g., emollients, lubricants, humectants, moisturizing agents, and conditioners), foaming agents, hair growth inhibitors, botanical extracts, antioxidants, antimicrobials, anti-inflammatory agents, astringents, anti-irritants, depilatory agents, medicinal agents, absorbants, fragrances, coloring agents (e.g., dyes and pigments) and exfoliating agents (e.g., loofa, seaweed, oatmeal, pumice, apricot seed, and the like). Exemplary embodiments of skin care agents include, but are not limited to, humectants such as glycerin, sorbitol, and propylene glycol, skin freshening and soothing agents such as menthol, aloe, allantoin and collagen, lubricants such as polyoxyethylene, and silicones (e.g. dimethicone, dimethiconol, dimethicone copolyol, stearyl dimethicone, cetyl dimethicone copolyol, phenyl dimethicone, cyclomethicone, etc.), sodium or potassium salts (e.g., lactylates, chlorides, sulfonates, and the like), vitamins and vitamin complexes (including vitamin precursors and derivatives), cocoates, metal oxides, oils (e.g., cocoa butter), dimethicone, allantoin, sucrose cocoate, oleyl lanolate, thiourea, tocopheryl acetate, PPG-33, undeceth-3, honey, algae and aloe barbadensis. The skin care ingredients can in some embodiments be present in amount of no more than about 35% (e.g., no more than about 30%, 25%, 20%, 15%, 12%, 10%, 8%, 6%, 4%, or no more than about 2%). The absorbents can be clays or clay-based compositions, kaolin, wood powder, sodium chloride, cyclodextrin, chalks, talcs, silicas, polytetrafluoroethylene, or the like, and can be present in amounts of no more than about 9% (e.g., no more than about 5% or no more than about 3%). Clays that may be added include bentonite, kaolin, combinations of the foregoing clays, and the like.

Exemplary coloring agents include dyes and pigments, for example, titanium dioxide, manganese violet, zinc oxide, an Ultramarine (e.g., Ultramarine Blue 4), Orange 4, Green 3, or other dyes or pigments approved for use in cosmetics, either alone or in combination. Coloring agents can in certain embodiments be added in an amount of no more than about 6% (e.g., no more than about 4%, 2%, 1%, 0.1%, 0.01%, 0.001%, 0.0001%, or even no more than about 0.00001%) and/or no less than about 0.000001% (e.g., no less than about 0.00001%, 0.0001%, 0.001%, 0.01%, 0.1%, or no less than about 1%) by weight.

Fragrances are odorants used to impart desirable smells to the composition and may further mask the less desirable odors of other components of the composition. Any fragrance approved for use in cosmetics may be employed. In certain embodiments, at least one fragrance ingredient can be added in an amount up to about 4% (e.g., up to about 2%, up to about 1.5% or up to about 1%).

### IV. RAZOR DETAILS

The glide member of the present invention can be used as a glide member on an article for use with a razor, comprising: a carrier forming a planar surface and at least one clearance region, through which a razor cartridge and razor handle can be connected, said carrier forming a frontal contact surface at one side of said planar surface and a rear contact surface on the opposing side of said planar surface, said carrier forming at least one glide member, such as a first glide member retaining structure and a second glide member retaining structure. The first glide member retaining structure and the second glide member retaining structure can be integrally formed of the same overall structure, or they can be separate and attached to one another. A first glide member and a second glide member are each attached said carrier forming via their respective glide member retaining structures. Each glide member has a skin contacting contact surface, and a plane drawn between these two surfaces forms the glide member skin contacting plane. Said skin contacting surface faces the same side of said carrier as said frontal contact surface. Those of skill in the art will understand that as the razor cartridge is passed along a portion of skin, the glide members will contact the skin as well as the cartridge blades and other features present on the skin contacting surface of the cartridge head. This forms the broader skin contacting surface. At rest, the skin contacting surface of the cartridge heads can be flush with the glide member skin contacting surface, or can be positioned positive (forward toward the user) or negative (away from the user).

The clearance region can be an aperture or a passage way for another structure to extend from the rear contact surface through to a structure on the frontal contact surface, or vice versa. In one embodiment the glide member carrier is used on a razor comprising a razor cartridge and a razor handle. The glide member carrier is preferably attached or otherwise restrained between the razor cartridge and the handle. The razor cartridge comprises a docking surface positioned opposite a shaving surface which is partially defined by one or more blades present on the cartridge. The docking surface, like on other replaceable razors systems is designed to be attached to the razor handle via a docking system and the docking surface. In one embodiment, the carrier is restrained between the handle and the cartridge by the opposing forces with the docking surface of the cartridge pushing on the frontal surface of the carrier and the handle/docking system pushing on the rear surface of the carrier. In effect, the carrier can be sandwiched between the handle and cartridge and is held in place by the pressure formed between these two structures.

In one embodiment, the carrier further comprises one or more alignment members which are used to orient the carrier with either the docking surface of the carrier, the docking system of the handle, or both. For example, in one embodiment, the carrier can include a receiving hole with the docking surface forming an alignment pin which would mate into the receiving hole when the carrier and cartridge are placed adjacent to one another. The male member can also be provided on the carrier with the receiving hole on the carrier. Similar features can be used on the interface between the rear surface of the carrier and the docking system. In some embodiments, alignment features are used on both interfaces between these three structures.

In one embodiment, the carrier is free of any cartridge retaining features, free of any handle retaining features, or free of both cartridge and handle retaining features. This is an important feature as it allows the carrier to float freely as a separate stand alone structure that can easily be removed by the user when the handle and cartridge are undocked. This is in notable contrast to other executions which typically retain their shave aid carriers or holders directly to the cartridge (such as in US Patent Publ. No 2008/0250646 and U.S. Pat. No. 7,811,553) as well as different from razors where the carrier/holder is attached directly to the handle or a portion of the handle. Typical means of attachment which have been discussed include tabs, flanges, hooks, anchors, clips and the like. Without intending to be bound by theory, it is believed that being free of mechanical and/or other permanent thermal or adhesive bonds to the cartridge housing and/or, the handle docking portion, allow the carrier to be readily changeable anytime the cartridge and corresponding handle are undocked, without need to unclip or otherwise apply force by hand to remove the carrier from a device that can include small easily breakable plastic parts as well as chemistry and blades.

In one embodiment, the docking system can be attached directly to the cartridge with or without the glide member carrier layered there-between. This added flexibility allows for the same razor system to be used along with the glide member carrier or without the glide member carrier without need for excessive restructuring of the device. This can allow for manufacturing flexibility as well as allow for user flexibility depending on their specific shaving needs. Importantly, this can allow a user to decide for themself whether they want to use the added features provided on the carrier for a given shave, based on their specific shaving needs on their overall preference or based on a shave by shave need. This added flexibility provides users with a single razor which can be used in various shaving conditions. For example where the user wants added lubrication and glide, such as where they do not have a shave preparation available, they can attach the glide member carrier to the razor. Where the user desires a razor cartridge in a smaller shaving head configuration, such as where they are shaving smaller or tighter areas, can shave with the glide member carrier removed. Without intending to be bound by theory, it is believed that users may find the present carrier particularly useful if shaving without shaving preparation as the glide members can provide extra lubrication to the skin. Additionally, the user may decide to include the carrier when shaving larger portions of skin such as the body, arms, or legs. Where the user wants to shave tighter areas, they can remove the carrier in the same session and access smaller regions or regions that have intricate curves or tight spots. The component nature of the present device allows a single razor to easily and quickly be modified by the user to suit different usage conditions.

In one embodiment, the docking system of the handle attaches to the razor cartridge via one more pins which may protrude outwardly and be pinchably attached into corresponding pin receiving members positioned at the docking surface of the cartridge, said pin receiving members forming opposing openings to receive and retain the pins. An example of this can be the docking system described and shown in U.S. Patent Application No. 2011/0067245 to Bridges et al. Other similar docking systems include those commercially available on the Gillette Atra razor system and the Gillette Mach 3 razor. In one embodiment, the pins and pin receiving members attach through one or more clearance regions formed in the carrier.

In one embodiment, the first glide member has a generally rounded shape. The portion of the glide member which contacts skin can be generally flat shaped with rounded edges to allow for improved feel. The skin contact surface can be smooth or include various forms of surface treatments, such as embossments, texturing, raised or depressed dimples, and so forth. In one embodiment, the first glide member has a different shape or surface treatment than the second glide member. Where multiple glide members are provided, they can have similar coloring, scent, shape and/or composition, or they can differ on one or more of these features.

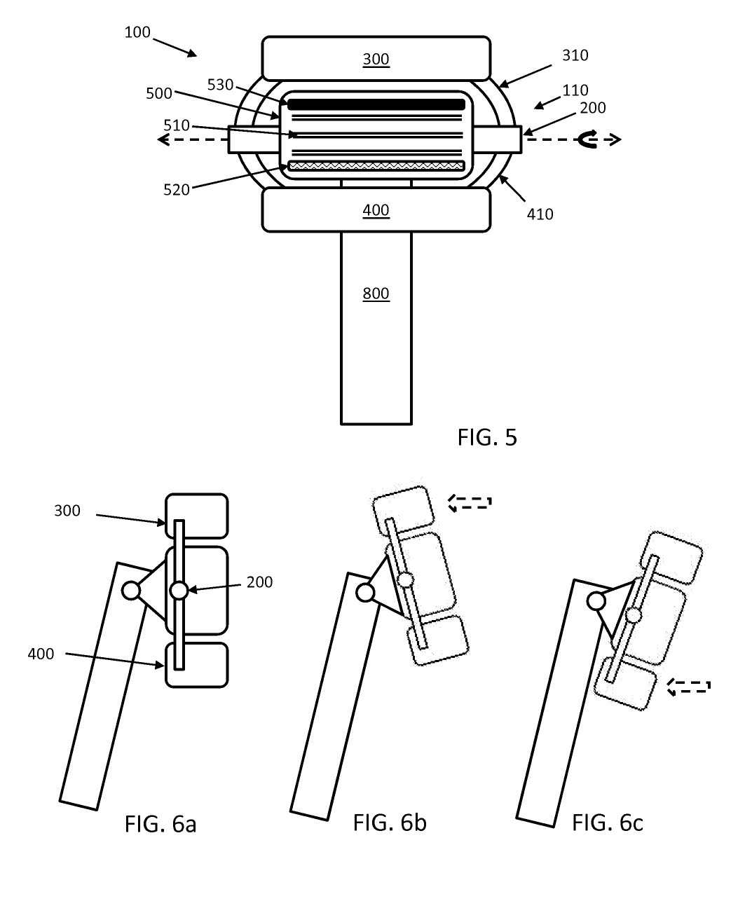

In one embodiment, a transverse longitudinal centerline formed in said carrier cutting said carrier in half can form an upper carrier region and a lower carrier region, wherein said upper carrier region is symmetrical to said lower carrier region. In some embodiments, such as shown in FIGS. 5-12, where the carrier has a single pivot axis, the single pivot axis and transverse longitudinal centerline can be the same line. In other embodiments, the glide members have separate pivots similar to the separate pivot axes shown in U.S. Pat. No. 7,811,553.

a. Kit Comprising a Plurality of Glide Member Carriers

Another embodiment of the present invention provides for a kit comprising a plurality of glide member carriers as described above. The glide member carriers can be the same or different, such as different glide member(s). In one embodiment, the kit comprises one or more razor cartridges provided along with the glide member carriers. Each razor cartridge can be paired with a glide member carrier and packaged together within the kit. In another embodiment, the glide member carriers are individually packaged in bags or tubs, with or without respective razor cartridges. In one embodiment, the kit further comprises a fully assembled razor (comprising handle, carrier, and cartridge) along with one or more of said glide member carriers and any additional razor cartridges.

FIG. 1a is a rear planar view of a razor of the present invention where the razor handle 1800 detached from a carrier 1200 comprising a first glide member 1300 and a second glide member 1400, said carrier forming a clearance region 1260 which is shown in this embodiment as two apertures positioned on far ends of the housing where the docking system of the handle comprising pins 1860 can dock onto the razor cartridge housing 1500 via a pair of pin receiving members 1560 extending outwards from the docking surface 1540 of said cartridge. A single clearance region can also be used. Also shown in FIG. 1a is the embodiment where a single pivot 1210 can be provided at the transverse centerline of the carrier. As shown here, the carrier can be generally identical across the two portions of the carrier separated by the transverse centerline. This would allow the user to rotate the carrier 180 degrees. Also shown would be where each glide member includes its own pivot 1230 and 1240. FIG. 1b shows the same razor components in an assembled configuration. FIG. 1c is a side profile view of the razor of FIGS. 1a and 1b. Preferably, the portion of the glide member(s) which contacts skin is generally flush with the skin contacting surface of the cartridge head. Also shown in FIG. 1c is an embodiment where the pin receiving members protrude through said clearance region formed in the carrier. Also within the scope of the invention would be where the docking system protrudes through the carrier to attach into receiving structures formed in the cartridge.

FIGS. 2a and 2b are rear planar views of two glide member carriers which are in accordance with at least one embodiment of the present invention. FIG. 2a shows two glide members which are different in shape. The first glide member is shown here formed of two separate members. Also shown in this figure is a clearance region in the form of a single aperture which can still allow one or more docking attachments to allow the handle and cartridge to be attached. FIG. 2b shows an embodiment with just a single glide member. The glide member can be forward or aft of the region which would hold the blades.

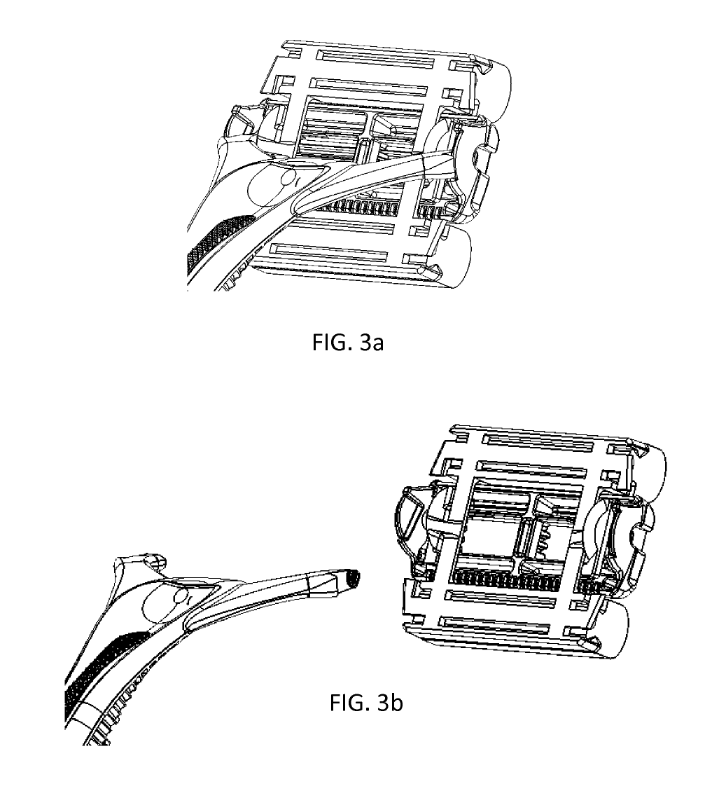

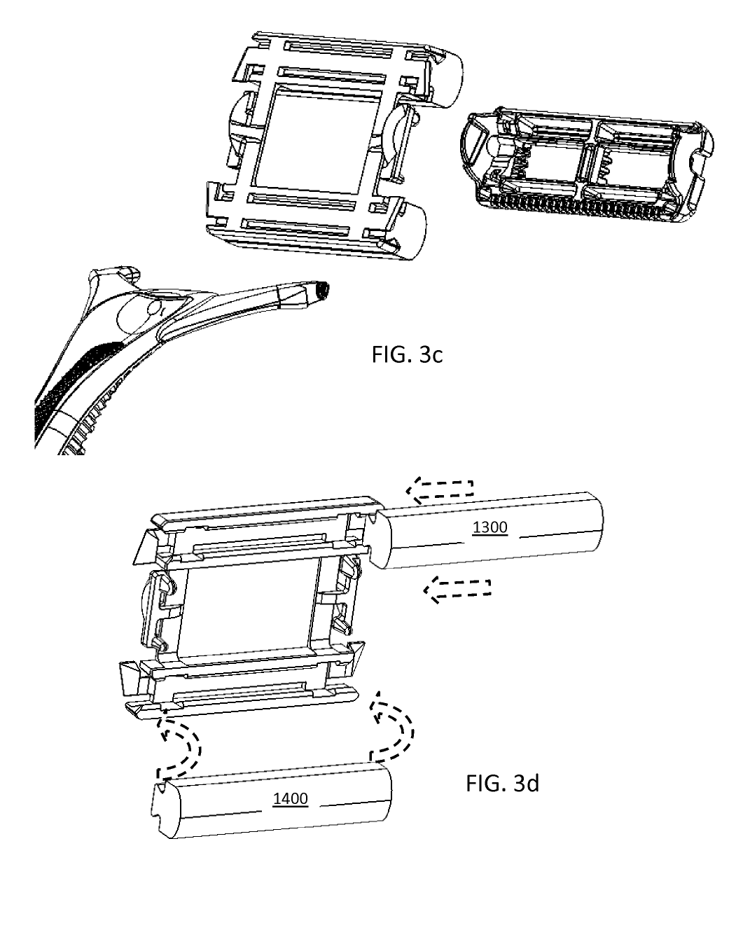

FIGS. 3a, 3b and 3c are rear angled views of another razor in accordance with at least one embodiment of the present invention. FIG. 3a shows a razor handle, carrier comprising two glide members, and a razor cartridge (with blades shown) in an assembled orientation. FIG. 3b shows the handle removed with blades removed from the cartridge head to facilitate viability. FIG. 3c shows each of these three components separated. Shown here, the docking system comprises a pair of outwardly protruding pins which dock into two receiving members formed in the cartridge. These receiving members are shown having arcoidal shape which allows the cartridge to smoothly rotate about a pivot axis formed by the opposing pins. In this embodiment, the carrier comprises corresponding arcoidal rotation embers to facilitate cartridge rotation.

FIG. 3d shows a frontal angled view of a carrier with glide members being attached. Glide member 1300 is shown being slide on from the left portion of the receiving member to the right portion. Glide member 1400 is shown being snap fitted or press fitted on. Those of skill in the art will appreciate that when press fitting the glide member on, it can be done in a rocking movement where one portion of the glide member can be placed into the receiving region, then pressure applied to the other portion. This can be done from side to side (i.e. push the left side in, then apply pressure to the right side, or vice versa), or top to bottom.

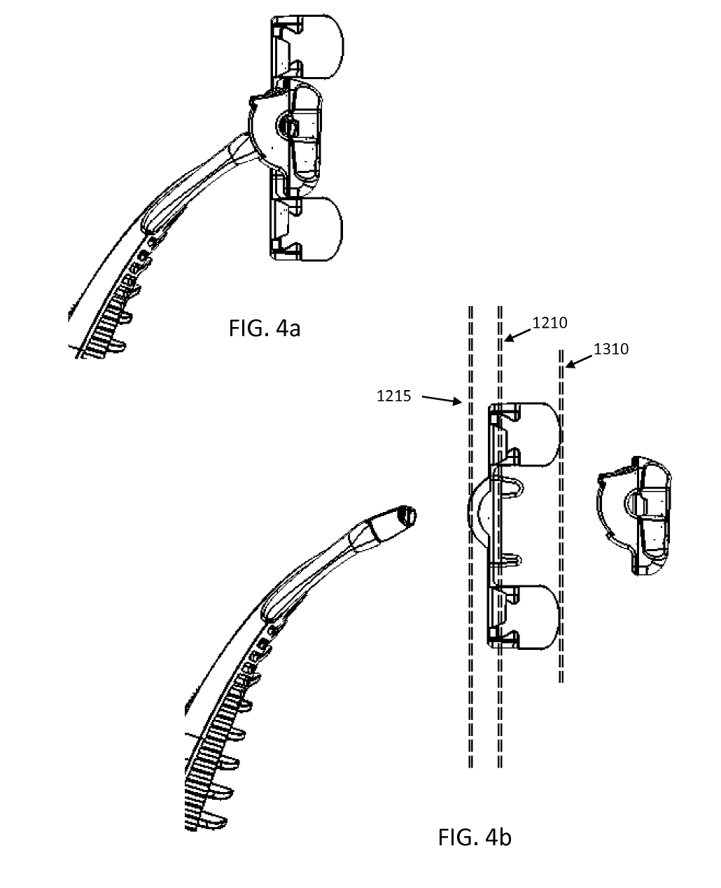

FIGS. 4a and 4b are side views of a razor shown in FIG. 3. FIG. 4a shows the razor assembled. FIG. 4b shows the handle, carrier and cartridge detached. Carrier has a frontal contact surface 1210 which faces the cartridge and a rear contact surface 1215 which faces the handle. Those of skill in the art will appreciate that the carrier need not be perfectly flat, such as shown here where the carrier forms two arcoidal rotation members which are the places where locations where the carrier contacts the handle. Also shown here is a glide member skin contacting surface formed by said first glide member. In this embodiment, where a first glide member and a second glide member are provided, they both form the same glide member skin contacting surface. The razor cartridge forms a portion of the broader skin contacting surface which can sit behind (a negative position) the skin contacting surface formed by the glide member(s), but can also be planar, or protrude outward (a positive position) from said skin contact surface formed by the glide member(s). Those of skill in the art will understand that the carrier can deflect forward toward the user or backward if pressure were applied. As such, it is possible that during use, pressure applied to the glide members can drive them backwards towards the handle and create a flatter overall skin contacting surface. Those of skill in the art will also appreciate that skin is elastic in nature and the body has many concave and convex curves. As such, the skin can adapt to engage the broader skin contacting surface even if it were not completely flat.

The devices shown in FIGS. 5-12 can also be used in accordance with the present invention, in particular where the carrier of the present invention forms the first and/or second glide member retaining structures.

FIG. 5 is a frontal view of a razor in accordance with at least one embodiment of the present invention. The razor consists of a head unit which is a razor cartridge 100 attached to a handle 800. Razor cartridge 100 comprises a cartridge housing 500 which carries at least one blade 510 (in this case shown with three blades), a guard 520 positioned at the front end of the cartridge (forward of the blades) and a lubricating strip 530 (also commonly referred to as a shave aid) positioned at the rear edge of the cartridge, aft of the blades. The head unit can also comprise one or more lubrication strips; as shown in FIG. 5, having a lubrication strip positioned forward of any blade(s). Non-limiting examples of known shave aids and lubrication strips as described in: U.S. Pat. Nos. 7,581,318, 7,069,658, 6,944,952, 6,594,904, 6,302,785, 6,182,365, D424,745, 6,185,822, 6,298,558 and 5,113,585, and 2009/0223057. The razor cartridge forms a shaving plane defined by how skin would contact the portion of the cartridge exposing the razor blade tips.

The head unit can be similar to blade units described in U.S. Pat. No. 5,661,907. The handle can be similar to those described in U.S. Pat. Nos. 5,855,071, 5,956,851 and/or 6,052,903. A connecting member can be provided to connect blade unit to handle and can be similar to connecting members described in U.S. Patent Publ. Nos. 2006/0080837A, and 2006/0080838A, and/or U.S. Pat. No. 8,033,023.

The razor cartridge forms a shaving surface where the blade(s) contact skin, and a docking surface opposite the shaving surface, where the razor cartridge attached directly or indirectly to said handle. In one embodiment, the razor cartridge further comprises a glide member retaining structure 110 comprising a first glide member 300 attached to the housing of the razor via at least one first glide member carrier 310. Shown here, the glide member carrier is a pair of curved first glide member retaining structures (or support arms). Those of skill in the art will appreciate that the structures can also be straight. The razor cartridge may further comprise a second glide member 400 attached to the housing of the razor via at least one second glide member carrier 410. Shown here, the carrier is a pair of curved second glide member retaining structures.

The first glide member and the second glide member are hingedly attached to the housing such that they pivot about a single pivot axis 200. The pivot axis 200 can be formed of a beam to which the glide member carrier (i.e. retaining structures) can be hingedly attached, or can be defined by a hinged connection between the first glide member and the second glide member carriers (such as a line of weakness between the carriers allowing them to fold into and away from the shaving plane). In one embodiment, the cartridge housing includes a pair of protrusions which extend sideways away from the housing from which the glide member carriers are hingedly attached (similar to the embodiment shown in FIG. 1). Although a pair of protrusions are shown, those of skill in the art will appreciate that a single protrusion, with a corresponding first glide member carrier and a second glide member carrier and cartridge housing can also be used, particularly if a retaining feature is included to attach the single protrusion with the receiving region on the housing.

The razor cartridge of the present invention may be used with a power or manual, disposable or a refillable razor system. The razor cartridge may also include multiple blades. For example, U.S. Pat. No. 7,168,173 generally describes a Fusion® razor that is commercially available from The Gillette Company which includes a razor cartridge with multiple blades. Additionally, the razor cartridge may include a guard as well as a glide member. A variety of razor cartridges can be used in accordance with the present invention. Nonlimiting examples of suitable razor cartridges, with and without fins, guards, and/or shave aids, include those marketed by The Gillette Company under the Fusion®, Venus® product lines as well as those disclosed in U.S. Pat. Nos. 7,197,825, 6,449,849, 6,442,839, 6,301,785, 6,298,558; 6,161,288, and U.S. Patent Publ. 2008/060201.

The terms “forward” and “aft”, as used herein, define relative position between features of the blade unit (i.e., razor cartridge). A feature “forward” of the at least one blade, for example, is positioned so that the surface to be treated with by the device encounters the feature before it encounters the at least one blade. For example, if the device is being stroked in its intended cutting direction, the guard is forward of the blade(s). A feature “aft” of the blade(s) is positioned so that the surface to be treated by the device encounters the feature after it encounters the blade(s), for example if the device is stroked in its intended cutting direction, the cap is disposed aft of the blade(s).

In one embodiment, the guard on the razor has at least one elongated flexible protrusions to engage a user's skin. In one embodiment, at least one flexible protrusion comprises flexible fins generally parallel to said one or more elongated edges. In another embodiment, said at least one flexible protrusion comprises flexible fins comprises at least one portion which is not generally parallel to said one or more elongated edges. Non-limiting examples of suitable guards include those used in current razor blades and include those disclosed in U.S. Pat. Nos. 7,607,230 and 7,024,776; (disclosing elastomeric/flexible fin bars); 2008/0034590 (disclosing curved guard fins); 2009/0049695A1 (disclosing an elastomeric guard having guard forming at least one passage extending between an upper surface and a lower surface).

The head unit is fixedly or removably attached to a handle. The attachment can be a direct attachment from head unit to a docking member of the handle, or the head unit can attach to an interconnect member which is then connected to the docking member of the handle. Those of skill in the art will appreciate that the design of this invention can be achieved as a structural modification to the razors shown in U.S. Pat. No. 7,811,553, or Venus Breeze type razors, with a notable changes to what is there described as the glide member and the glide member holder.

FIGS. 6a-6c are side views of a razor in accordance with at least one embodiment of the present invention. FIG. 6a shows a razor in an at rest position while 2b shows the razor having cartridge pivoting backwards where the rear portion of the cartridge (the portion forming the first glide member, and the razor cartridge cap) are deflected back towards the razor handle. FIG. 6c shows a similar razor where the cartridge pivots forward such that the front portion of the cartridge (the portion forming the second glide member and the guard) are deflected towards the razor handle. These figures show an embodiment where the glide member carriers are static and do not bend. Although pairs of glide member retaining structures are shown, each or both of the glide members can also be merely attached with single structures. In one embodiment, where single retaining structures are used, they can be used on opposing sides or both on the same side of the razor (for example, where the first glide member retaining structure is attached to said housing by a retaining structure on the left side of the razor cartridge, and the second glide member can be attached to the housing via a single retaining structure which is attached on the right side of the razor cartridge, or vice versa.

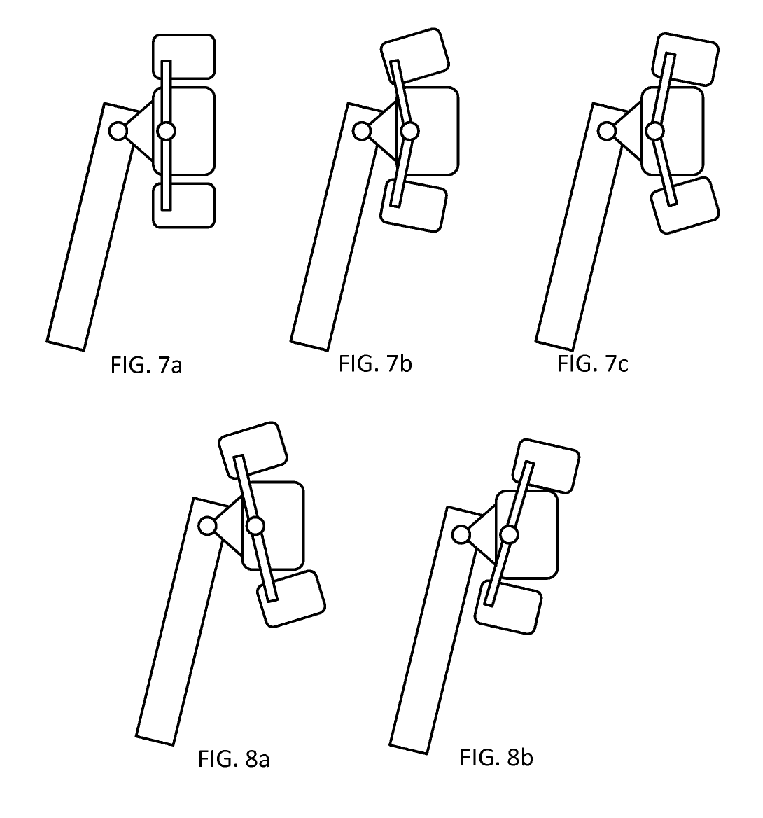

FIGS. 7a-7c are side views of a razor in accordance with at least one embodiment of the present invention. Similar to the embodiment shown in FIGS. 6a-6c, the cartridge can pivot backwards and forwards like existing cartridges. Here, the glide member retaining structures are shown pivoting along pivot axis 200 such that the glide members can deflect in backwards behind the shaving plane (FIG. 7b), and forward towards the user's skin (FIG. 7c). In one embodiment, the said first glide member carrier and said second glide member carrier form an angle of from about 165 degrees to about 195 degrees, or about 180 degrees when said razor is in an at rest position. In effect, the glide members rest at or about the shaving plane. When force is applied to the glide members, said first glide member carrier and said second glide member carrier can form a maximum deflection angle of from about 190 degrees to about 270 degrees, or from about 200 degrees to about 225 degrees, from the pivot axis (similar to a situation as shown in FIG. 7b). The razor can also have a minimum deflection angle of from about 135 degrees to about 180 degrees, or from about 150 degrees to about 175 degrees from the pivot axis (similar to a situation as shown in FIG. 7c). Those of skill in the art would appreciate that the minimum deflection angle can also be defined as the position where the glide members come into contact with another portion of the cartridge.

In one embodiment, said first glide member carrier and said second glide member carrier are biased from each other to remain in an at rest position. Those of skill in the art will appreciate that force applied by the skin during shaving can be sufficient do cause one or both glide members to deflect backwards into a position shown by FIG. 7b. The biasing force should be sufficiently low that the glide members deflect uncontrollably. Similarly, the biasing force should not be so high that the user does not need to apply excessive force which could cause discomfort or interfere with normal shaving strokes. In one embodiment, the biasing force is similar to the biasing force of the glide member retaining members used on Venus Breeze type razors.

FIGS. 8a-8b are side views of a razor in accordance with at least one embodiment of the present invention where the glide retaining structure is pivotably attached to said cartridge housing and pivots like a see saw such that the retaining structures. In one embodiment, the first glide member carrier and said second glide member carrier can form a fixed angle, such as from about 165 degrees to about 195 degrees, or about 180 degrees. As shown in FIGS. 8a and 8b, the first glide member carrier and the second glide member carrier can pivot together while maintaining said fixed angle.

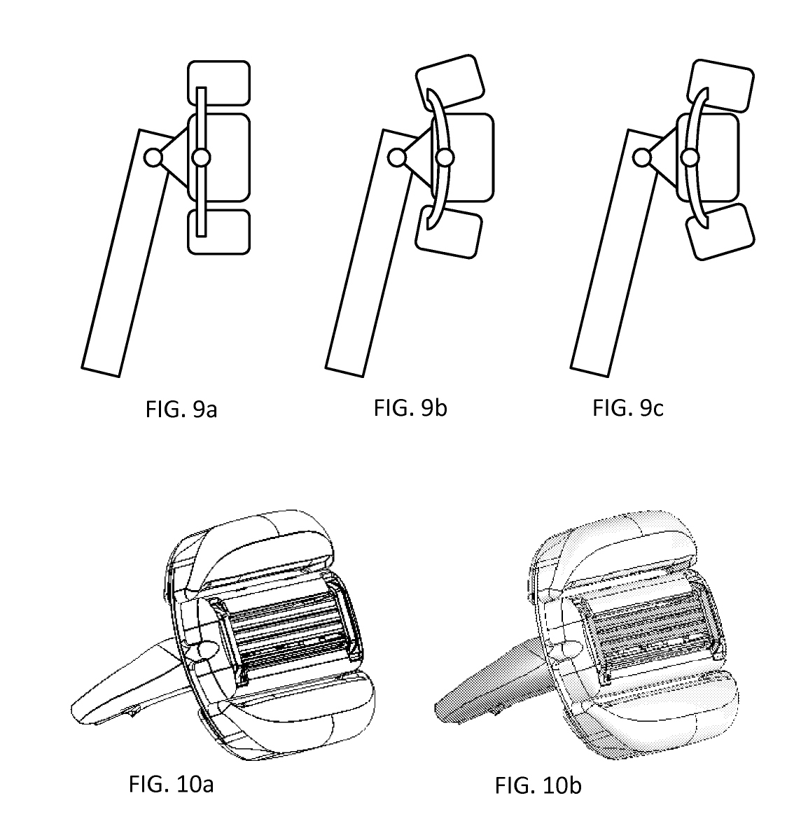

FIGS. 9a-9c are side views of a razor in accordance with at least one embodiment of the present invention, wherein one or both of the carriers are made of flexible material such that the retaining structures can bend forward and back if the rest of the carrier is in a locked position such as locked into the at rest position. In this or any other embodiment of this invention, it may be useful to allow consumers to lock the carrier from pivoting. If such an embodiment is desired, it may be useful to include flexible materials in the retaining structures such that the glide members can still deflect during use but keep the carrier in a locked position.

FIGS. 10a-10b are side views of a razor in accordance with at least one embodiment of the present invention. The cartridge shown in FIG. 10a is in black and white line drawing while 10b is shown with surface shading.

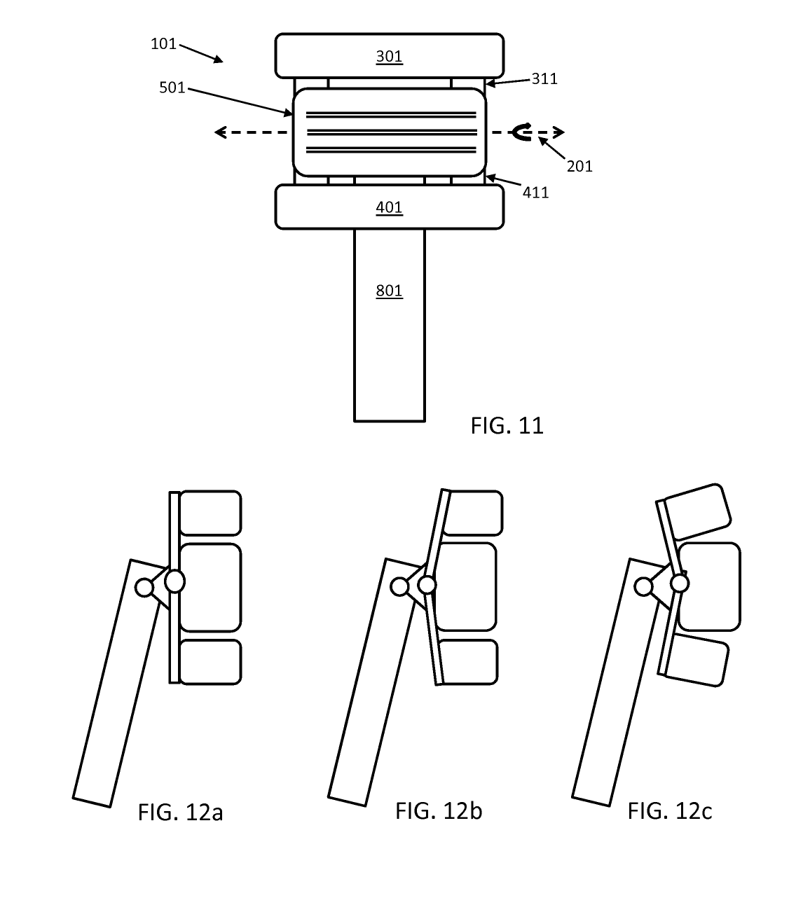

FIG. 11 is a frontal view of a razor in accordance with at least one embodiment of the present invention where the carrier does not wrap around the periphery of said cartridge housing. In this embodiment, the carrier sits behind or as part of the rearward portion of the cartridge housing, away from the shaving plane. FIGS. 12a-12c are side views of a razor in accordance with at least one embodiment of the present invention where the glide members pivot backwards (12b) and forward (12c).

In one embodiment, the glide member retaining structure 110 or one of the retaining structures may be mounted so that it is removable from the cartridge body by the consumer (e.g., if the consumer wishes to add a glide member holder to a cartridge that does not include one), or, alternatively, may be permanently mounted on the cartridge body or integrally molded with the cartridge body. In one embodiment, the retaining structure 110 removably attaches to the cartridge by engagement of one or more clips onto the back surface of the housing of the head unit. The glide member carrier may be engaged with the housing by sliding the housing under clips and then deflecting clips to snap them in place as explained in U.S. Pat. No. 7,811,553.

In one embodiment, the glide member and the carrier are integrally formed (meaning they are formed in the same process, such as where they are both cast together in a single mold). In an embodiment where they are not integrally formed, the glide member can be attached to said glide member via a mechanical attachment, such as where the glide member is molded or otherwise fitted around a retaining portion of the carrier, or they can be bonded via adhesive or heat. The portion of the carrier which attaches to the glide member can be similar to that used on the Venus Breeze® line of 2-in-1 razor, and/or the Schick® Intuition® line of razors. In another embodiment, the glide member and glide member holder can be similar to those disclosed U.S. Patent Publ. Nos. 2006/225285A and 2006/080837A, and/or U.S. Pat. No. 7,811,553.

In some embodiments, hinges connecting the first glide member carrier to the pivot axis and/or the second glide member carrier, are formed of an elastomeric material, e.g., a block copolymer. The elastomeric material is generally selected to provide a soft flex, so that the glide members deflect readily upon contact with the user's skin, while also providing a good spring return to the wings. For example, the elastomeric material may have a flexural modulus of about 100 to 300 psi.

In one embodiment, the invention relates to a method of making an article comprising a step of providing a carrier forming at least one glide member retaining structure, said at least one glide member retaining structure forming a receiving member; providing a first glide member; attaching said first glide member onto said receiving member. These steps can be performed for one or more glide members, the steps can be performed concurrently for each glide member, or can be performed in series (i.e. not concurrently).

Where the glide member is formed by extrusion, the extruded soap blend can be passed through an extrusion die to form it into a profile with interlocking member (like the dovetail) and then is left to cool and cut to an appropriate length (the soap can also be cut while warm but is more susceptible to deformation while handling). An alternative process is to extrude the soap into an intermediate form (such as a cylinder having round or “D” cross sectional shape) to form a blank or billet. The billet can then be immediately cut to length and press into a wing shape with an interlocking member while the soap is still warm. The advantage of adding the additional pressing step is that it allows a more complex and desirable form to be added to the soap than the extrusion alone.

Once molded or extruded (and optionally pressed) into shape, the glide members can be left to cool to aid handling before being slid or snapped into the glide member receiving region formed in the carrier. In another embodiment, the step of attaching the glide member can be done while the glide member is still warm. Further, it is possible to design the glide member profile so that it can more easily be slid in lengthwise along the receiving region (such as sliding it along a receiving track) or clipped or snap fit in vertically to be retained by opposing pressure applied to the retained portion of the glide member, or slid in by the direction of the shaving stroke. Various shapes can be used to allow the glide member to be retained within the retaining region.

In another embodiment, said step of providing said glide member comprises a step of cooling said glide member to room temperature before said step of attaching said glide member to said receiving member. In one embodiment, the step of providing said first glide member comprises the steps of: providing a soap feed;: extruding said soap feed to form a extruded soap; cutting said extruded soap to form a first glide member; and cooling said first glide member.

A method of assembling a razor comprising the steps of: providing an article comprising: a carrier forming a planar surface and at least one clearance region, said carrier forming a frontal contact surface at one side of said planar surface and a rear contact surface on the opposing side of said planar surface, said carrier forming at least a first glide member retaining structure; a first glide member attached to said carrier forming a skin contacting contact surface, wherein said skin contacting surface is on the same side of said carrier as said frontal contact surface; providing a razor cartridge; providing a razor handle; positioning said article between said razor cartridge and said razor handle; attaching said razor handle to said razor cartridge through said at least one clearance region formed in said carrier. Said carrier need not be not fastened to said razor cartridge or said handle.

### V. PACKAGING

Without intending to be bound by theory, it is now believed that the present invention allows for packaging flexibility, whereas other similar razors with soap components had previously required being packaged into containers that were effectively air tight (low levels of Water Vapour Transmission Rate and/or Oxygen Transmission Rate). Since the present glide member composition has improved product stability, and is less susceptible to beading and/or other formation stability issues, it is believed that the present product can be packaged into less robust containers. Although the present products can be packaged into air tight tub and lid containers, they can also be packaged into plastic bags or other similar less substantial packages that can provide less waste and lower cost. In one embodiment, the razor, razor cartridge, and/or glide member carrier comprising the glide member can be packaged into a non-hermetically sealed package or bag. The package or bag can also be merely non-air tight.

### VI. SOAP BASE STABILITY TESTING

### Beading Evaluation Test Method:

Beading can be measured by placing samples of the soap wings in open glass jars and storing at 5° C., 30° C. 75% RH and 40° C. 75% RH. Measurements can also be collected at 70% RH. Samples are left for 1 month, 2 months and 3 months and visually assessed for beading. Beading is defined as moisture droplets that accumulate on the surface of the soap. Typically, the soap surface is dry with no evidence of moisture present. Razors having glide member compositions in accordance with Examples 1—Results are reported as beading being present or not.

### VII. EXAMPLES

The invention is further described in the following examples, which do not limit the scope of the invention described in the claims.

### EXAMPLES

| | Example 1 | Example 2 | Example 3 | Example 4 | Example 5 |
|---|---|---|---|---|---|
| Soap noodles | 97.3 | 97.8 | 97.0 | 96.8 | 98.3 |
| Titanium | 0.5 | 0.5 | 0.5 | 0.5 | 0.5 |
| dioxide | | | | | |
| Perfume | 1.2 | 1.2 | 0.5 | 1.2 | 1.2 |
| PEG 90M | 1.0 | 0.5 | — | — | — |
| PEG-115M | — | — | 2.0 | — | — |
| PEG-7M | | | — | 1.5 | — |

The soap noodles are made via a conventional process involving a crutching step and a vacuum drying step. The soap noodles are then added to an amalgamator. The ingredients of water, titanium dioxide, PEG and perfume are then added to the amalgamator and mixed for about 30 to 60 seconds. This soap mixture is then processed through conventional milling, plodding, and stamping steps to yield the finished bar soap compositions.

For non-limiting exemplary purposes, the soap noodle utilized in these examples have the following approximate composition: about 65% sodium palmate, 16% sodium palm kernalate, from about 0.5%-8% glycerin, 1% palm acid and about 1% sodium chloride, the balance being unsaponifiables and water. These percentage amounts are by weight of the soap noodle. PEG-90M, PEG-115M and PEG-7M are available from the DOW Chemical company under the trade name Polyox™.

It should be understood that every maximum numerical limitation given throughout this specification includes every lower numerical limitation, as if such lower numerical limitations were expressly written herein. Every minimum numerical limitation given throughout this specification includes every higher numerical limitation, as if such higher numerical limitations were expressly written herein. Every numerical range given throughout this specification includes every narrower numerical range that falls within such broader numerical range, as if such narrower numerical ranges were all expressly written herein.

All parts, ratios, and percentages herein, in the Specification, Examples, and Claims, are by weight and all numerical limits are used with the normal degree of accuracy afforded by the art, unless otherwise specified. Further, as used herein, where a group is described to be “comprising of” a list of group members, that group may also “consist essentially of” or “consist of” that same list of group members.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A shaving cartridge comprising:
a housing having a front edge and a rear edge;
one or more shaving blades between the front edge and the rear edge;
a glide member carrier; and
at least one glide member composition mounted on the glide member carrier, the glide member composition comprising, less than about 15% by weight of a hygroscopic component, and a soap base.

2. The shaving cartridge of claim 1, wherein said hygroscopic component is selected from the group consisting of glycerine, a polyhydric alcohol, or a mixture thereof.

3. The shaving cartridge of claim 1, wherein the level of hygroscopic component is from about 15 to about 0.5 wt % of said glide member composition.

4. The shaving cartridge of claim 1, wherein the glide member composition is free or essentially free of said hydroscopic component.

5. The shaving cartridge of claim 4, wherein the glide member composition is free or essentially free of both glycerine and any polyhydric alcohols.

6. The shaving cartridge of claim 1, wherein glycerine is present at a level of less than about 8 wt %.

7. The shaving cartridge of claim 1, wherein said glide member composition further comprises from about 0.1% to about 10 wt % polyoxyethylene.

8. The shaving cartridge of claim 1, further comprising a pyrithione source at a level of from about 0.01% to about 5%, by weight of the soap base.

9. The shaving cartridge of claim 1, wherein the pyrithione source is selected from a group consisting of zinc pyrithione, sodium pyrithione, pyrithione acid, dipyrithione, chitonsan pyrithione, magnesium disulfide pyrithione, and combinations thereof.

10. The shaving cartridge of claim 1, wherein said pyrithione source is in the form of a platelet having a mean particle diameter of about 0.5 microns to about 10 microns, a median particle diameter of about 0.5 microns to about 10 microns, and a thickness of about 0.6 microns to about 15 microns.

11. The shaving cartridge of claim 1, wherein said soap base further comprises an additional antibacterial agent selected from the group consisting of triclocarban; triclosan; a halogenated diphenylether; hexachlorophene; 3,4,5-tribromosalicylanilide; salts of 2-pyridinethiol-1-oxide; and mixtures thereof.

12. The shaving cartridge of claim 1, wherein said soap base further comprises a pH adjusting agent selected from a group consisting of ammonia solution, triethanolamine, diethanolamine, monoethanolamine, potassium hydroxide, sodium hydroxide, soluble carbonate salts, and combinations thereof.

13. The shaving cartridge of claim 12, wherein said soluble carbonate salt is selected from a group consisting of sodium carbonate, potassium carbonate, ammonium carbonate, aluminum carbonate, magnesium carbonate, sodium bicarbonate, potassium bicarbonate, and combinations thereof.

14. The shaving cartridge of claim 1, further comprising a silicone polymer selected from the group consisting of dimethicone PEG-7 panthenyl phosphate, dimethicone PEG-7 phosphate, dimethicone PEG-7 undecylenate, dimethicone/methicone copolymer, perfluoronoylethyl dimethicone methicone copolymer, dimethicone/vinyl dimethicone crosspolymer in dimethicone, vinyl dimethicone/lauryl dimethicone crosspolymer in mineral oil, vinyl dimethicone/lauryl dimethicone crosspolymer in squalane, vinyl dimethicone/methicone silsesquioxane crosspolymer, squalene and lauryl dimethicone/polyglycerin-3 crosspolymer, triethylhexanoin and lauryl dimethicone/polyglycerin-3 crosspolymer, and dimethicone/polyglycerin-3 crosspolymer and dimethicone, PEG/PPG-20/6 dimethicone, behenoxydimethicone, C24-28 alkyl methicone, dimethicone/vinyl dimethucine crosspolymer, and C12-C14 Pareth-12.

15. The shaving cartridge of claim 1, wherein the glide member composition further comprises at least one of polyethylene, polybutene, mineral oil composition, or a mixture thereof.

16. The glide member of claim 1, within the glide member composition is formed by extrusion

17. A method of forming a glide member composition for use with a razor comprising:
a. providing a soap base ingredients into a reaction vessel;
b. saponofying said soap base ingredients to form a liquid soap base
c. removing hygroscopic components from said liquid soap base;
d. drying said liquid soap base into soap noodles; and
e. extruding said soap noodles into a soap base.

18. The method of claim 17, wherein the step of removing said hygroscopic components includes removing all or essentially all glycerin.

19. The method of claim 18, further comprising a step of attaching said extruded soap base onto a glide member carrier.
